(19) United States
(12) Patent Application Publication
(10) Pub. No.: US 2026/0188261 A1
(43) Pub. Date: Jul. 2, 2026

(54) DATA DRIVER AND DISPLAY DEVICE INCLUDING SAME

(71) Applicant: LG Display Co., Ltd., Seoul (KR)

(72) Inventors: Sang Hun BAEK, Paju-si (KR); Myung Kook MOON, Paju-si (KR)

(73) Assignee: LG Display Co., Ltd., Seoul (KR)

(21) Appl. No.: 19/383,417

(22) Filed: Nov. 7, 2025

(30) Foreign Application Priority Data
Dec. 30, 2024 (KR) 10-2024-0200767

(51) Int. Cl. G09G 3/3275; G09G 3/20; G09G 3/3233

(52) U.S. Cl. CPC G09G 3/3275; G09G 3/2096; G09G 3/3233; G09G 2300/0819; G09G 2300/0842; G09G 2300/0861; G09G 2310/027; G09G 2310/08; G09G 2320/0247; G09G 2330/021; G09G 2340/0435; G09G 2370/08; G09G 2370/10

(57) ABSTRACT

A display device can include a display panel including subpixels having light-emitting elements, a data driver configured to supply a data voltage or a park voltage to the subpixels through a data line, and a timing controller configured to control the data driver and provide a park voltage control value to the data driver. The data driver generates the park voltage based on the park voltage control value.

### CROSS-REFERENCE TO RELATED APPLICATION

This application claims priority to Korean Patent Application No. 10-2024-0200767, filed in the Republic of Korea on Dec. 30, 2024, which is hereby incorporated by reference as if fully set forth herein.

### BACKGROUND

### Field of the Disclosure

The present disclosure relates to a data driver and a display device including the same.

### Discussion of the Related Art

As information technology develops, the market for display devices, which serve to convey information to users, is growing. Accordingly, the use of display devices such as light emitting display (LED) devices, quantum dot display (QDD) devices, and liquid crystal display (LCD) devices is increasing.

The display devices described above include a display panel including subpixels, a driver that outputs driving signals for driving the display panel, and a power supply that generates power to be supplied to the display panel or the driver.

The display devices described above can display images by causing selected subpixels to transmit light or directly emit light when driving signals, such as a scan signal and a data signal, are supplied to the subpixels formed on the display panel.

### SUMMARY OF THE DISCLOSURE

Accordingly, the present disclosure is directed to a data driver and a display device including the same that substantially obviate one or more problems due to limitations and disadvantages of the related art.

An object of the present disclosure is to implement a circuit such that a data driver directly generates a park voltage used for variable refresh rate (VRR) driving to optimize voltage change timing at the time of switching modes between VRR driving and normal driving.

Another object of the present disclosure is to shorten output and level change time of the park voltage.

Another object of the present disclosure is to reduce the cost needed to implement a power supply by deleting a park voltage generation circuit included in the power supply.

Additional advantages, objects, and features of the present disclosure will be set forth in part in the description which follows and in part will become apparent to those having ordinary skill in the art upon examination of the following or can be learned from practice of the present disclosure. The objectives and other advantages of the present disclosure can be realized and attained by the structure particularly pointed out in the written description and claims hereof as well as the appended drawings.

To achieve these objects and other advantages and in accordance with the purpose of the present disclosure, as embodied and broadly described herein, a display device includes a display panel including subpixels each having a light-emitting element, a data driver configured to supply a data voltage or a park voltage to the subpixels through a data line, and a timing controller configured to control the data driver and provide a park voltage control value to the data driver, wherein the data driver generates the park voltage based on the park voltage control value.

According to aspects of the present disclosure, the park voltage control value can be transmitted in the form of a packet through a communication interface connected between the timing controller and the data driver.

According to aspects of the present disclosure, the park voltage can be changed into voltages of various levels in response to the park voltage control value calculated according to driving conditions of the display panel.

According to aspects of the present disclosure, the data driver can include a first digital-to-analog converter configured to generate the park voltage, a second digital-to-analog converter configured to generate the data voltage, and a selector configured to selectively output one of the park voltage or the data voltage.

According to aspects of the present disclosure, the selector can output the park voltage instead of the data voltage in response to a park voltage enable signal applied from the timing controller.

According to aspects of the present disclosure, the first digital-to-analog converter can include a resistor string circuit configured to divide a voltage into a plurality of levels based on a first reference voltage and a second reference voltage and output the divided voltages, and a controller configured to change the level of the park voltage based on the voltages output from the resistor string circuit and the park voltage control value and output the level-changed park voltage.

According to aspects of the present disclosure, the data driver can include a plurality of data drivers, and the plurality of data drivers can generate the park voltage based on a park voltage reference voltage value output from a representative data driver.

According to aspects of the present disclosure, the park voltage can be output when the display panel operates in a variable refresh rate (VRR) driving mode.

According to aspects of the present disclosure, the VRR driving can include a refresh frame for applying a data voltage through a data line connected to a subpixel of the display panel, and an anode reset frame for applying the park voltage through the data line.

According to aspects of the present disclosure, the subpixel can include a driving transistor for supplying a driving current to the light-emitting element, and a transistor connected between the data line and the driving transistor, wherein the transistor can be turned on in the refresh frame such that the data voltage is supplied to the driving transistor, and the transistor can be turned off during a period in which the park voltage is provided to the data line in the anode reset frame.

In another aspect of the present disclosure, a data driver includes a first digital-to-analog converter configured to generate a park voltage and gamma reference voltages, a second digital-to-analog converter configured to generate a data voltage based on the gamma reference voltages, and a selector configured to selectively output one of the park voltage or the data voltage, wherein the first digital-to-analog converter generates the park voltage based on an external park voltage control value.

According to aspects of the present disclosure, the selector can output the park voltage instead of the data voltage in response to an external park voltage enable signal.

According to aspects of the present disclosure, the first digital-to-analog converter can include a resistor string circuit configured to divide a voltage into a plurality of levels based on a first reference voltage and a second reference voltage and output the divided voltages, and a controller configured to change a level of the park voltage based on the voltages output from the resistor string circuit and the park voltage control value and output the level-changed park voltage.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light-emitting display device;

FIG. 2 is an example diagram showing a circuit configuration of a subpixel according to aspects of the present disclosure;

FIG. 3 is a diagram for describing a driving method of a display panel implemented based on the subpixel of FIG. 2, and FIG. 4 is a diagram for describing driving characteristics of the display panel implemented based on the subpixel of FIG. 2;

FIG. 5 is a block diagram schematically showing components of a light-emitting display device capable of varying a park voltage according to an embodiment of the present disclosure, and FIG. 6 is a diagram for describing characteristics according to a park voltage control method according to an embodiment of the present disclosure;

FIG. 7 is a block diagram showing some of the components of the light-emitting display device capable of varying a park voltage according to an embodiment of the present disclosure in detail, FIG. 8 is an example diagram showing a configuration of a first digital-to-analog converter illustrated in FIG. 7 in more detail, and FIG. 9 is an example diagram of a configuration of a data driver for uniform park voltage output; and

FIG. 10 is a diagram for describing a difference between an embodiment of the present disclosure and a comparative example, and FIG. 11 is a diagram for describing advantages that can be obtained when a light-emitting display device is implemented based on an embodiment of the present disclosure.

### DETAILED DESCRIPTION OF THE EMBODIMENTS

Reference is now made in detail to embodiments of the present disclosure, examples of which can be illustrated in the accompanying drawings. In the following description, where a detailed description of relevant known functions or configurations can unnecessarily obscure aspects of the present disclosure, a detailed description of such known functions or configurations can be omitted for brevity. The progression of processing steps and/or operations described is an example, and the sequence of steps and/or operations is not limited to that set forth herein and can be changed, with the exception of steps and/or operations necessarily occurring in a particular order.

Advantages and features of the present disclosure, and implementation methods thereof are clarified through the following example embodiments described with reference to the accompanying drawings. The present disclosure may, however, be embodied in different forms and should not be construed as limited to the example embodiments set forth herein. Rather, these example embodiments are provided so that this disclosure can be sufficiently thorough and complete to assist those skilled in the art to understand the inventive concepts fully without limiting the protected scope of the present disclosure.

A display device according to aspects of the present disclosure can be implemented as a television, a video player, a personal computer (PC), a home theater, an automobile electrical device, a smartphone, etc., but is not limited thereto. The display device according to aspects of the present disclosure can be implemented as a light emitting display (LED) device, a quantum dot display (QDD) device, a liquid crystal display (LCD) device, etc. However, for convenience of description, a light emitting display device that directly emits light based on inorganic light-emitting diodes or organic light-emitting diodes is used as an example of the display device below.

In addition, a transistor which will be described below can be implemented as an n-type transistor, a p-type transistor, or a combination of n-type and p-type transistors. The transistor is a three-electrode element including a gate, a source, and a drain. The source is an electrode that supplies carriers to the transistor. In the transistor, carriers start to flow from the source. The drain is an electrode through which carriers are discharged from the transistor. In other words, carriers flow from the source to the drain in the transistor.

In the case of a p-type transistor, carriers are holes, and thus the source voltage is higher than the drain voltage such that the holes can flow from the source to the drain. Since the holes flow from the source to the drain in the p-type transistor, the current flows from the source to the drain. On the other hand, in the case of an n-type transistor, carriers are electrons, and thus the source voltage is lower than the drain voltage such that the electrons can flow from the source to the drain. Since the electrons flow from the source to the drain in the n-type transistor, the current flows from the drain to the source. However, the source and drain of the transistor can be changed depending on the applied voltage. Considering this, one of the source and drain is described as a first electrode, and the other of the source and drain is described as a second electrode in the following description.

Here, the term “can” fully encompasses all the meanings and coverages of the term “may” and vice versa.

Now, various embodiments of the present disclosure will be described referring to the drawings. All the components of each display device according to all embodiments of the present disclosure are operatively coupled and configured.

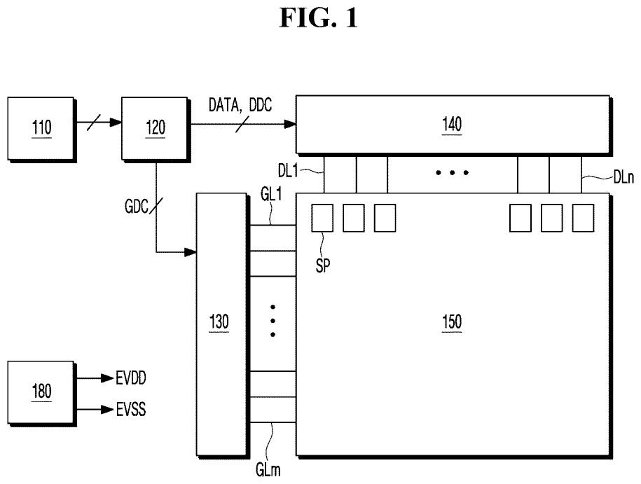

FIG. 1 is a block diagram schematically showing a light-emitting display device.

As shown in FIG. 1, the light-emitting display device can include a timing controller 120, a gate driver (gate driving circuit) 130, a data driver (data driving circuit) 140, a display panel 150, and a power supply 180.

An image provider (set or host system) 110 can output various driving signals in addition to external image data signals or image data signals (data signals) stored in an internal memory. The image provider 110 can supply data signals and various driving signals to the timing controller 120.

The timing controller 120 can output a gate timing control signal GDC for controlling the operation timing of the gate driver 130, a data timing control signal DDC for controlling the operation timing of the data driver 140, and various synchronization signals. The timing controller 120 can supply a data signal DATA supplied from the image provider 110 along with the data timing control signal DDC to the data driver 140. The timing controller 120 can be formed as an integrated circuit (IC) and mounted on a printed circuit board, but is not limited thereto.

The gate driver 130 can output a gate signal (or gate voltage) in response to the gate timing control signal GDC supplied from the timing controller 120. The gate driver 130 can supply gate signals to subpixels included in the display panel 150 through gate lines GL1 to GLm. Here, m can be a real number, e.g., a positive integer. The gate driver 130 can include a shift register and a level shifter. The level shifter can output clock signals and a start signal based on signals and voltages output from the timing controller 120 and the power supply 180. The shift register operates based on clock signals and the start signal and can output gate signals through the gate lines GL1 to GLm. The gate driver 130 can be formed as an IC or can be formed directly on the display panel 150 in a gate-in panel structure, but is not limited thereto.

The data driver 140 can sample and latch a data signal DATA in response to the data timing control signal DDC supplied from the timing controller 120, convert a digital data signal into an analog data voltage based on a gamma reference voltage, and output the same. The data driver 140 can supply a data voltage to subpixels included in the display panel 150 through data lines DL1 to DLn. Here, n can be a real number, e.g., a positive integer. The data driver 140 can be formed as an IC and mounted on the display panel 150 or on a printed circuit board, but is not limited thereto.

The power supply 180 can generate a high-level voltage and a low-level voltage based on an external input voltage, and output the same through a high-level power line EVDD and a low-level power line EVSS. The power supply 180 can generate and output voltages (gate high voltage and gate low voltage) needed to drive the gate driver 130 and voltages needed to drive the data driver 140 as well as the high-level voltage and the low-level voltage.

The display panel 150 can display an image in response to driving signals including a gate signal and a data voltage, and driving voltages including a high-level voltage and a low-level voltage. The subpixels of the display panel 150 can directly emit light. The display panel 150 can be manufactured based on a rigid or flexible substrate such as a glass, silicon, or polyimide substrate. The subpixels that emit light can be composed of red, green, and blue pixels, or red, green, blue, and white pixels.

For example, one subpixel SP can be connected to the first data line DL1, the first gate line GL1, the high-level power line EVDD, and the low-level power line EVSS, and can include a pixel circuit composed of a switching transistor, a driving transistor, a capacitor, and an organic light-emitting diode. The subpixel SP used in the light-emitting display device directly emits light and thus has a complicated circuit configuration. In addition, a compensation circuit that compensates for deterioration of the driving transistor that supplies a driving current necessary to drive the organic light-emitting diode as well as the organic light-emitting diode that emits light also has a complicated configuration. Therefore, the subpixel SP is simply illustrated in the form of a block.

Meanwhile, in the above description, the timing controller 120, the gate driver 130, and the data driver 140 have been described as individual components. However, one or more of the timing controller 120, the gate driver 130, and the data driver 140 can be integrated into one IC depending on implementation of the light-emitting display device.

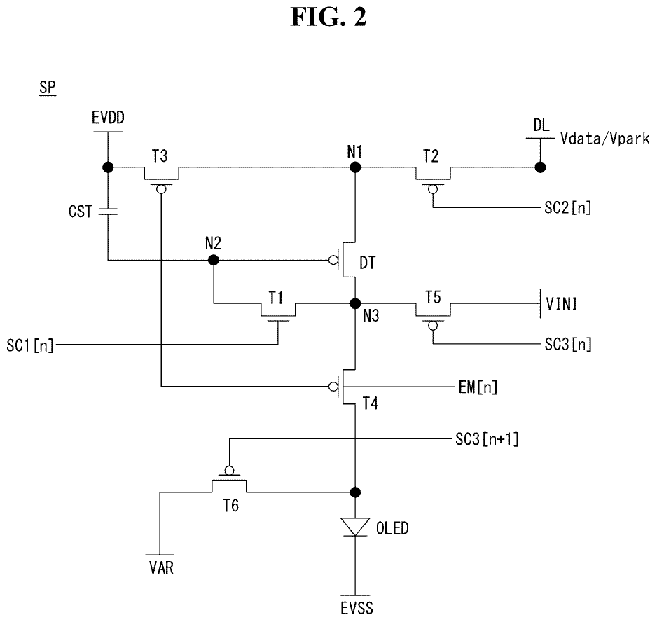

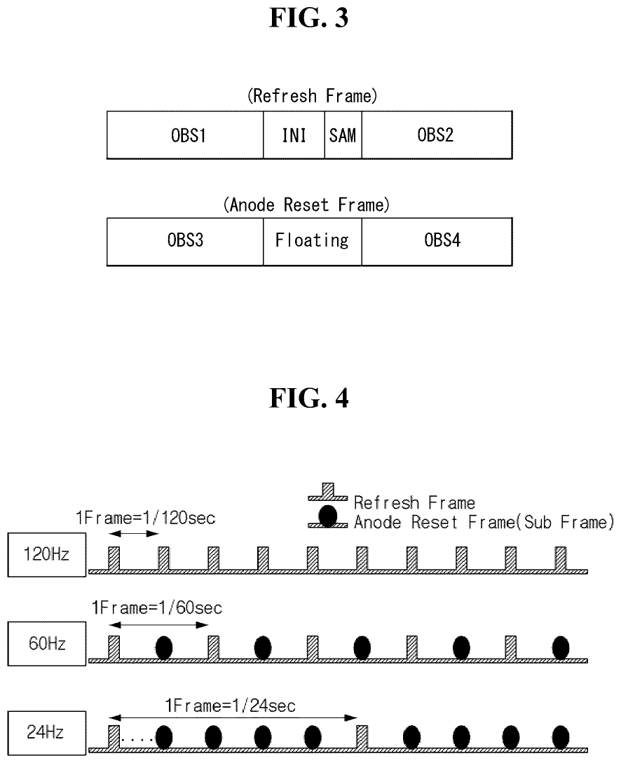

FIG. 2 is an example diagram showing a circuit configuration of a subpixel according to aspects of the present disclosure, FIG. 3 is a diagram for describing a driving method of a display panel implemented based on the subpixel of FIG. 2, and FIG. 4 is a diagram for describing driving characteristics of the display panel implemented based on the subpixel of FIG. 2.

As illustrated in FIG. 2, a subpixel SP can include a first transistor T1, a second transistor T2, a third transistor T3, a fourth transistor T4, a fifth transistor T5, a sixth transistor T6, a driving transistor DT, a capacitor CST, and a light-emitting element OLED.

The first transistor T1 can have a gate electrode connected to a first scan line SC1[n], a first electrode connected to a second node N2, and a second electrode connected to a third node N3. The first transistor T1 can be turned on in response to a first scan signal applied through the first scan line SC1[n]. When the first transistor T1 is turned on, the threshold voltage of the driving transistor DT can be sampled.

The second transistor T2 can have a gate electrode connected to a second scan line SC2[n], a first electrode connected to a data line DL, and a second electrode connected to a first node N1. The second transistor T2 can be turned on in response to a second scan signal applied through the second scan line SC2[n]. When the second transistor T2 is turned on, a data voltage Vdata or a park voltage Vpark applied through the data line DL can be transmitted to the first node N1.

The third transistor T3 can have a gate electrode connected to an emission control signal line EM[n], a first electrode connected to a high-level voltage line EVDD, and a second electrode connected to the first node N1. The third transistor T3 can be turned on in response to an emission control signal applied through the emission control signal line EM[n]. When the third transistor T3 is turned on, a high-level voltage applied through the high-level voltage line EVDD can be transmitted to the first node N1.

The fourth transistor T4 can have a gate electrode connected to the emission control signal line EM[n], a first electrode connected to the third node N3, and a second electrode connected to an anode of the light-emitting element OLED. The fourth transistor T4 can be turned on in response to an emission control signal applied through the emission control signal line EM[n]. When the fourth transistor T4 is turned on, a driving current generated from the driving transistor DT can be transmitted to the light-emitting element OLED. When the fourth transistor T4 is turned on, the light-emitting element OLED can emit light based on the driving current generated from the driving transistor DT.

The fifth transistor T5 can have a gate electrode connected to a third scan line SC3[n], a first electrode connected to a first voltage line VINI, and a second electrode connected to the third node N3. The fifth transistor T5 can be turned on in response to a third scan signal applied through the third scan line SC3[n]. When the fifth transistor T5 is turned on, a first voltage applied through the first voltage line VINI can be transmitted to the third node N3. When the fifth transistor T5 is turned on together with the first transistor T1, residual charge present in the gate electrode of the driving transistor DT and a second electrode of the capacitor CST can be initialized.

The sixth transistor T6 can have a gate electrode connected to a fourth scan line SC3[n+1], a first electrode connected to a second voltage line (VAR), and a second electrode connected to the anode of the light-emitting element OLED. The sixth transistor T6 can be turned on in response to a fourth scan signal applied through the fourth scan line SC3[n+1]. When the sixth transistor T6 is turned on, a second voltage applied through the second voltage line VAR can be transmitted to the anode of the light-emitting element OLED. When the sixth transistor T6 is turned on, residual charge present in the electrode of the light-emitting element OLED can be initialized. Meanwhile, the fourth scan line SC3[n+1] can be selected as the third scan line for driving the subpixel related to the next gate line of the subpixel SP illustrated in FIG. 2.

The driving transistor DT can have the gate electrode connected to the second node N2, a first electrode connected to the first node N1, and a second electrode connected to the third node N3. The driving transistor DT can operate based on the data voltage Vdata stored in the capacitor CST and generate a driving current.

The capacitor CST can have a first electrode connected to the high-level voltage line EVDD and the second electrode connected to the second node N2. The capacitor CST can store the data voltage Vdata for a certain period of time and then transfer the same to the gate electrode of the driving transistor DT.

The light-emitting element OLED can have the anode connected to the second electrode of the fourth transistor T4 and a cathode connected to a low-level voltage line EVSS. The light-emitting element OLED can emit light in response to the driving current transferred through the turned-on fourth transistor T4.

Meanwhile, although FIG. 2 illustrates an example in which the first transistor T1 is implemented as an n-type transistor based on an oxide semiconductor, and the second transistor T2, the third transistor T3, the fourth transistor T4, the fifth transistor T5, the sixth transistor T6, and the driving transistor DT are implemented as p-type transistors based on a polycrystalline semiconductor, the embodiment is not limited thereto.

A display panel implemented based on the subpixel of FIG. 2 can improve image characteristics (e.g., smooth movement, reduced visual artifacts, and improved responsiveness) based on not only normal driving but also variable refresh rate (VRR) driving in which the driving frequency changes.

As illustrated in FIG. 2 and FIG. 3, the display panel can perform refresh frame driving for renewing a frame (or data voltage) and anode reset frame driving for minimizing frame brightness reduction (or brightness difference) during VRR operation.

For example, a refresh frame can include a first bias period OBS1, an initialization period INI, a sampling period SAM, and a second bias period OBS2, and an anode reset frame can include a third bias period OBS3, a floating period Floating, and a fourth bias period OBS4.

During the first bias period OBS1 and the second bias period OBS2 included in the refresh frame, the data voltage Vdata can be applied to the data line DL. In addition, during the third bias period OBS3 and the fourth bias period OBS4 included in the anode reset frame, the park voltage Vpark can be applied to the data line DL.

For example, during the third bias period OBS3 and the fourth bias period OBS4 in which the park voltage Vpark is applied, the first transistor T1, the second transistor T2, the third transistor T3, the fourth transistor T4, the fifth transistor T5, and the driving transistor DT, excluding the sixth transistor T6, can be turned off, but the present disclosure is not limited thereto.

According to VRR, power consumption can be reduced by increasing or decreasing the refresh rate of the display panel needed to update the data voltage Vdata in response to high-speed or low-speed operation conditions. For example, as shown in FIG. 4, a refresh rate of 120 Hz means that the refresh frame operates at 120 Hz (repeated at a cycle of 1/120 sec), a refresh rate of 60 Hz means that the refresh frame operates at 60 Hz (repeated at a cycle of 1/60 sec), and a refresh rate of 24 Hz means that the refresh frame operates at 24 Hz (repeated at a cycle of 1/24 sec).

Under high-speed driving conditions such as operation at 120 Hz, a refresh frame that can refresh the data voltage Vdata (refresh an image) can be included for each frame. On the other hand, under low-speed driving conditions such as operation at 60 Hz or 24 Hz, a refresh frame appears at intervals of N frames (N being an integer equal to or greater than 2), and an anode reset frame in which the park voltage Vpark is applied to subpixels SP instead of the data voltage Vdata can be included between refresh frames.

For example, when the refresh rate is 60 Hz, one anode reset frame is provided between refresh frames, and when the refresh rate is 24 Hz, the anode reset frame can be repeated four times between refresh frames.

According to the embodiment, the anode reset frame can be interpreted as a subframe. In addition, the anode reset frame can be provided under low-speed driving conditions, such as when there is little movement in an image or when a still image is displayed.

During the anode reset frame, the park voltage Vpark that replaces the data voltage can be formed in a parasitic capacitor between the data line DL and the gate electrode of the driving transistor DT and can cause coupling with at least one of the first node N1 and the second node N2. The gate-source voltage of the driving transistor DT can be affected by change in the park voltage Vpark. Therefore, the park voltage Vpark can be used to minimize (prevent) hysteresis change in the driving transistor DT during the anode reset frame.

Meanwhile, the park voltage Vpark can be varied according to the frame rate in order to solve problems (such as flicker and dimming due to characteristics and brightness deviation of the display panel) that occur when the display panel is driven at a low speed, which will be described below.

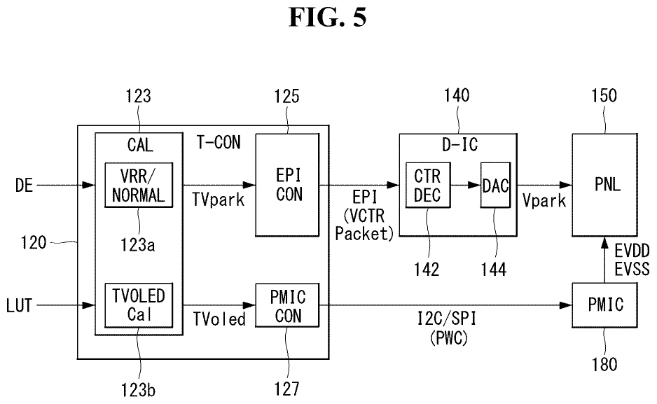

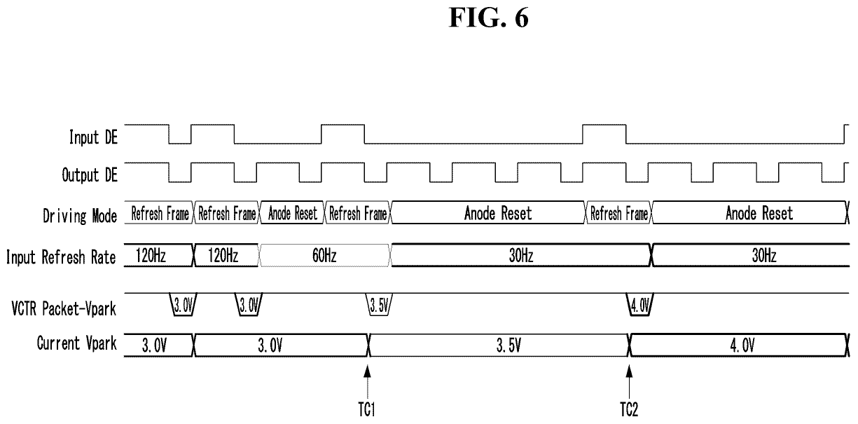

FIG. 5 is a block diagram schematically showing a configurations of a light-emitting display device capable of varying the park voltage according to an embodiment of the present disclosure, and FIG. 6 is a diagram for describing characteristics according to a park voltage control method according to an embodiment of the present disclosure.

As illustrated in FIG. 5, the light-emitting display device according to an embodiment of the present disclosure can include a timing controller (T-CON) 120, a data driver (D-IC) 140, a power supply (PMIC) 180, and a display panel (PNL) 150.

The timing controller 120 can include a voltage calculator (CAL) 123 including a mode determination circuit (VRR/NORMAL) 123a and a driving voltage calculation circuit (TVOLED Cal) 12b, a data communication circuit (EPI CON) 125, and a power controller (PMIC CON) 127.

The voltage calculator 123 can calculate a voltage value (e.g., a park voltage control value TVPark and a driving voltage control value TVoled) according to a driving frequency at the time of entering a VRR mode or returning to a normal mode. The mode determination unit 123a can determine whether the light-emitting display device has entered the VRR mode or returned to the normal mode based on an input data enable signal DE. The driving voltage calculation unit 123b can calculate a target voltage value based on data included in a lookup table LUT and a mode signal output from the mode determination unit 123a.

When the light-emitting display device has entered the VRR mode, the voltage calculator 123 can output a park voltage control value TVPark set appropriately for the current VRR mode. When the light-emitting display device has returned to the normal mode, the voltage calculator 123 can output the target driving voltage control value TVoled. The park voltage control value TVPark and the driving voltage control value TVoled can be output as K-bit digital values (K being an integer equal to or greater than 2) such that they can be changed to various voltage levels according to the driving conditions of the display panel 150. For example, the park voltage control value TVPark and the driving voltage control value TVoled can be digital values indicating preset voltage levels.

The voltage calculator 123 can calculate a voltage value at the time when a new data enable signal is input after a vertical blank period ends when returning to the normal mode, but the present disclosure is not limited thereto.

The data communication unit 125 can configure the park voltage control value TVPark output from the voltage calculator 123 in the form of a voltage control packet VCTR Packet and transmit the same through a first interface connected to the data driver 140. For example, the data communication unit 125 can transmit the voltage control packet (VCTR Packet) through the Embedded Clock Point-Point Interface (EPI) based on the embedded clock method. Hereinafter, the first interface will be described as an example of the EPI.

The power controller 127 can configure a power control signal PWC based on the driving voltage control value TVoled output from the voltage calculator 123 and transmit the same through a second interface connected to the power supply 180. For example, the power controller 127 can transmit the power control signal PWC through I2C or Serial Peripheral Interface (SPI).

The power supply 180 can generate a high-level voltage and a low-level voltage based on the power control signal PWC output from the power controller 127. The power supply 180 can output the high-level voltage and the low-level voltage through the high-level power line EVDD and the low-level power line EVSS connected to the display panel 150.

The data driver 140 can include a decoder (CTR DEC) 142 and a digital-to-analog converter (DAC) 144. The decoder 142 can decode a voltage control packet VCTR Packet received by the data driver 140 and output a park voltage control value TVPark. The digital-to-analog converter 144 can convert the park voltage control value TVPark output from the decoder 142 into an analog park voltage Vpark suitable for driving the display panel 150 and output the same.

According to the embodiment, the park voltage control value TVPark output from the timing controller 120 can be transmitted to the data driver 140 through data communication. Then, the data driver 140 can generate a park voltage Vpark based on the park voltage control value TVPark transmitted from the timing controller 120 and apply the park voltage Vpark to the display panel 150.

As illustrated in FIG. 6, the light-emitting display device according to the embodiment can generate the park voltage Vpark or change the level of the park voltage Vpark based on a signal included in the voltage control packet VCTR Packet. Here, referring to a first voltage change period TC1 and a second voltage change period TC2 of FIG. 6, the level of the park voltage Current Vpark currently applied to the display panel with almost no time delay can be changed at the time of changing the level of the park voltage Vpark in the embodiment. That is, the light-emitting display device according to the embodiment can shorten the level change time of the park voltage Vpark.

In this way, the light-emitting display device according to the embodiment can transmit the park voltage control value TVPark needed to generate the park voltage Vpark or change the level of the park voltage Vpark to the data driver 140 through the first interface having a relatively high transmission speed compared to the second interface. In addition, the data driver 140 can generate the park voltage Vpark or change the level thereof based on the park voltage control value TVPark with almost no time delay and apply the same to the display panel. As a result, the light-emitting display device according to the embodiment can improve problems (such as flicker and dimming due to brightness deviation) that occur when the display panel is driven at a low speed.

Meanwhile, in FIG. 6, Input DE represents a data enable signal applied to the timing controller, and Output DE represents a data enable signal output from the timing controller. In addition, Driving Mode represents that refresh frame driving and anode reset frame driving change depending on the driving mode, and Input Refresh Rate represents that the refresh rate changes to 120 Hz, 60 Hz, or 30 Hz in response to mode change.

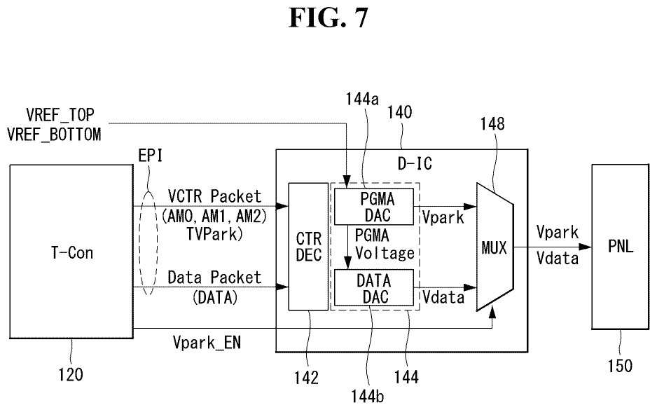

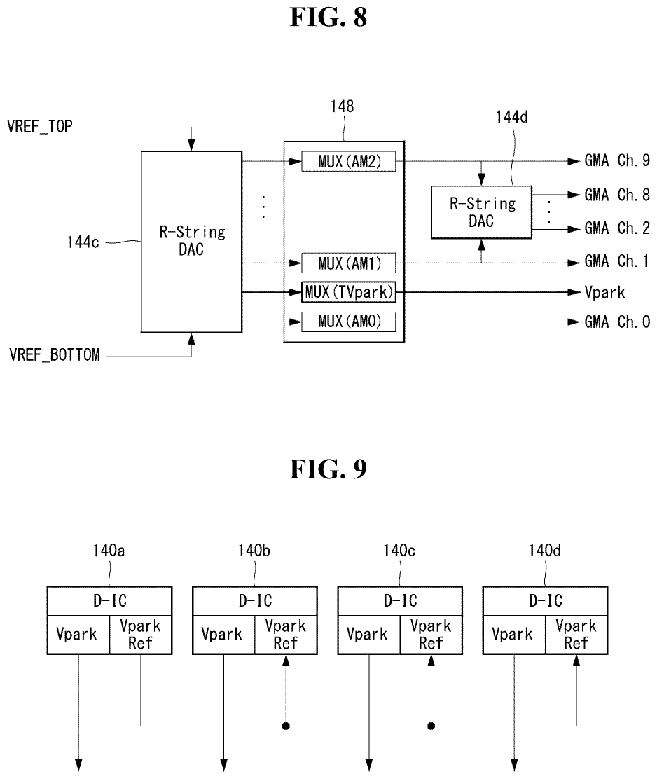

FIG. 7 is a block diagram showing some of the components of the light-emitting display device capable of varying a park voltage according to an embodiment of the present disclosure in detail, FIG. 8 is an example diagram showing a configuration of a first digital-to-analog converter shown in FIG. 7 in more detail, and FIG. 9 is an example diagram showing a configuration of the data driver for uniform park voltage output.

As shown in FIG. 7, the timing controller 120 can transmit a voltage control packet VCTR Packet and a Data Packet through an EPI connected to the data driver 140. The voltage control packet VCTR Packet can include gamma voltage control values AM0 to AM2 and a park voltage control value TVPark, and the data packet can include a data signal DATA.

The data driver 140 can include a decoder 142, a digital-to-analog converter 144 including a first digital-to-analog converter (PGMA DAC) 144a and a second digital-to-analog converter (DATA DAC) 144b, and a selector (MUX) 148.

The decoder 142 can decode the packets transmitted through the EPI and separately output the voltage control values AM0, AM1, M2, and TVPark included in the voltage control packet VCTR Packet and the data signals DATA included in the data packet. Meanwhile, it should be noted that FIG. 7 separately illustrates a voltage control packet VCTR Packet and a Data Packet in order to aid in understanding configurations of packets transmitted through the EPI.

The digital-to-analog converter 144 can generate a park voltage Vpark and a data voltage Vdata based on a first reference voltage VREF_TOP, a second reference voltage VREF_BOTTOM, and the voltage control values AM0, AM1, AM2, and TVPark included in the voltage control packet VCTR Packet.

The first digital-to-analog converter 144a can generate the park voltage Vpark and a gamma reference voltage PGMA Voltage based on the first reference voltage VREF_TOP, the second reference voltage VREF_BOTTOM, and the voltage control values AM0, AM1, AM2, and TVPark. The first digital-to-analog converter 144a can change the output voltage levels in various manners based on the programmable input first reference voltage VREF_TOP, the second reference voltage VREF_BOTTOM, and the voltage control values AM0, AM1, AM2, and TVPark, and thus can be defined as a programmable gamma circuit.

The second digital-to-analog converter 144b can generate a data voltage Vdata based on the data signal DATA and the gamma reference voltage PGMA Voltage output from the first digital-to-analog converter 144a. The selector 148 can output the park voltage Vpark instead of the data voltage Vdata in response to a park voltage enable signal Vpark_EN. The data voltage Vdata or the park voltage Vpark output from the selector 148 can be applied to a subpixel through a data line connected to the display panel 150.

As illustrated in FIG. 7 and FIG. 8, the first digital-to-analog converter 144a can include a first resistor string circuit (R-string DAC) 144c, a controller 144e, and a second resistor string circuit 144d.

The first resistor string circuit 144c can divide a voltage into a plurality of levels based on the first reference voltage VREF_TOP and the second reference voltage VREF_BOTTOM and output the same. The second resistor string circuit 144d can divide voltages output from a third controller MUX (AM1) and a fourth controller MUX (AM2) into a plurality of levels and output the same.

The controller 144e can change the level of the gamma reference voltage PGMA Voltage based on the voltages output from the first resistor string circuit 144c and the gamma voltage control values AM0 to AM2 and output the level-changed gamma reference voltage PGMA Voltage. In addition, the controller 144e can change the level of the park voltage Vpark based on the voltages output from the first resistor string circuit 144c and the park voltage control value TVPark and output the level-changed park voltage Vpark.

The controller 144e can include a first controller MUX (AM0), a second controller MUX (TVPark), a third controller MUX (AM1), and a fourth controller MUX (AM2). The first controller MUX (AM0) operates based on the first gamma voltage control value AM0 and can output a voltage corresponding to a first gamma reference voltage GMA Ch. 0. The second controller MUX (TVPark) operates based on the park voltage control value TVPark and can output the park voltage Vpark. The third controller MUX (AM1) operates based on the second gamma voltage control value AM1 and can output a voltage corresponding to a second gamma reference voltage GMA Ch. 1. The fourth controller MUX (AM2) operates based on the third gamma voltage control value AM2 and can output a voltage corresponding to a third gamma reference voltage GMA Ch.9.

The first controller MUX (AM0), the second controller MUX (TVPark), the third controller MUX (AM1), and the fourth controller MUX (AM2) are illustrated as multiplexer circuits for convenience. However, they can be composed of switches that turn on/off voltage nodes such that voltages having various levels are selectively output based on the voltage control values AM0, AM1, AM2, and TVPark.

An example of a case in which a target park voltage value is 3.0 V will be described below.

The timing controller 120 can set a value of 512 indicating 3.0 V as a park voltage control value TVPark, include the value in a voltage control packet VCTR Packet, and then transmit the same to the data driver 140. Here, if the first reference voltage VREF_TOP applied to the data driver 140 is 6 V and the second reference voltage VREF_BOTTOM is 2 V, the park voltage Vpark can be generated according to a formula such as “2 V+{(6 V−2 V)×512/2047}=3 V”. Accordingly, the park voltage Vpark can be generated as one of the levels in the range of the gamma reference voltages PGMA Voltage output from the first controller MUX (AM0) to the fourth controller MUX (AM2) in response to the park voltage control value TVPark.

The above example illustrates that the digital-to-analog converter operates based on an 11-bit data value, and thus 0 V is generated when the data bit value is 0 and 6 V is generated when the data bit value is 2047. Although FIG. 8 illustrates an example in which the gamma reference voltages GMA Ch. 0 to GMA Ch. 9 for a total of 10 channels are output from the first digital-to-analog converter 144a in order to aid in understanding, the present disclosure is not limited thereto. In addition, FIG. 8 illustrates an example in which the second controller MUX (TVPark) is provided between the first controller MUX (AM0) and the third controller MUX (AM1) and outputs a value between the gamma reference voltages output through the first controller MUX (AM0) and the third controller MUX (AM1), but the present disclosure is not limited thereto.

A light-emitting display device can require multiple data drivers instead of a single data driver depending on the resolution, size, and implementation method of the display panel. In this case, the park voltage Vpark can be generated for each data driver, and can also be implemented as follows.

As illustrated in FIG. 9, a second data driver 140b to a fourth data driver 140d can generate and output park voltages Vpark based on a park voltage reference voltage value Vpark Ref output from the first data driver 140a.

As illustrated in FIG. 9, if the first data driver 140a, which is one of the first data driver 140a to the fourth data driver 140d, is set as a representative data driver and the park voltage Vpark is generated based on the park voltage reference voltage value Vpark Ref output from the first data driver 140a, the output uniformity can be improved. Accordingly, when park voltages Vpark are output using a plurality of data drivers, it is possible to prevent or minimize problems caused by voltage deviation between data drivers.

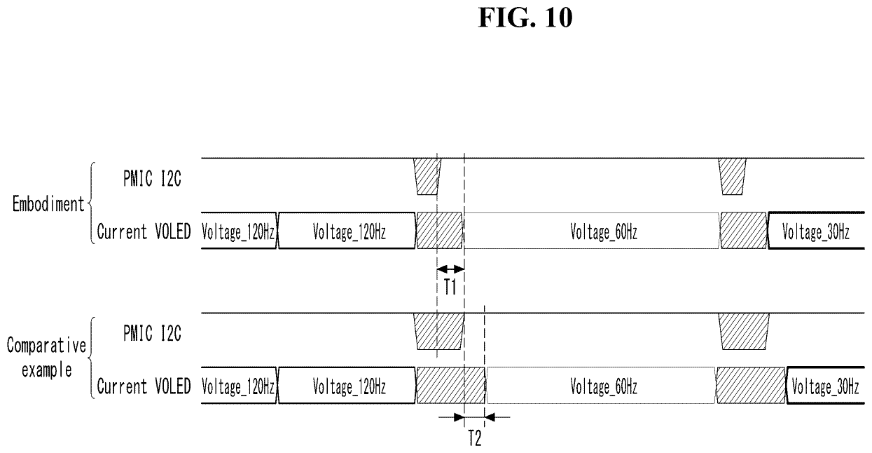

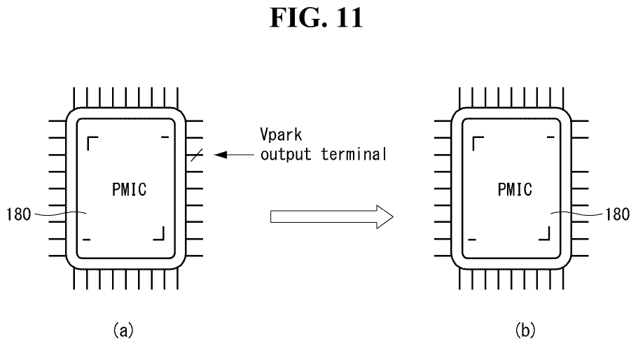

FIG. 10 is a diagram for describing the difference between the embodiment of the present disclosure and a conventional technology, and FIG. 11 is a diagram for describing advantages that can be obtained when a light-emitting display device is implemented based on the embodiment of the present disclosure.

Referring to FIG. 5, FIG. 10, and FIG. 11, the light-emitting display device implemented based on the conventional technology can output the park voltage Vpark from the power supply 180 or change the level thereof based on a power control signal PWC output from the timing controller 120 differently from the configuration and operation shown in FIG. 5. In this case, since the park voltage Vpark output from the power supply 180 is applied to the display panel 150 via the data driver 140, the output timing and the level change timing of the park voltage Vpark can be delayed.

As illustrated in FIG. 10, the light-emitting display device implemented based on the embodiment of the present disclosure generates and outputs the park voltage from the data driver instead of the power supply, and thus the configuration of a control signal PMIC I2C for controlling the power supply can be minimized. As a result, the embodiment can reduce the time for transmitting the control signal PMIC I2C by a first time T1 compared to the comparative example. In addition, the embodiment can reduce the time for changing the driving voltage Current VOLED by a second time T2 compared to the comparative example.

As shown in FIG. 11, when a light-emitting display device is implemented based on the embodiment of the present disclosure, a park voltage output terminal of the power supply 180 can be eliminated. FIG. 11 in (a) shows a state before the park voltage output terminal is eliminated, and FIG. 11 in (b) shows a state after the park voltage output terminal is eliminated.

Therefore, the light-emitting display device implemented based on the embodiments of the present disclosure can shorten the time for controlling the power supply 180, and reduce the cost needed to implement the power supply since the circuit for generating the park voltage can be eliminated.

The present disclosure has the effect of implementing a circuit such that a data driver directly generates a park voltage used for VRR driving based on packets received through communication connected to a timing controller, thereby optimizing voltage change timing at the time of switching modes between VRR driving and normal driving. In addition, the present disclosure has the effect of implementing a circuit such that a park voltage is generated and changed based on a relatively fast communication method, thereby reducing the output and level change time of the park voltage. Furthermore, the present disclosure has the effect of reducing the cost needed to implement a power supply by allowing the park voltage to be generated from the data driver and deleting a park voltage generation circuit included in the power supply.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

What is claimed is:

1. A display device comprising:
a display panel including subpixels, each of the subpixels having a light-emitting element;
a data driver configured to supply a data voltage or a park voltage to the subpixels through data lines; and
a timing controller configured to control the data driver and provide a park voltage control value to the data driver,
wherein the data driver generates the park voltage based on the park voltage control value.

2. The display device of claim 1, wherein the park voltage control value is transmitted in the form of a packet through a communication interface connected between the timing controller and the data driver.

3. The display device of claim 1, wherein the park voltage is changed into voltages of various levels in response to the park voltage control value determined according to driving conditions of the display panel.

4. The display device of claim 1, wherein the data driver comprises:
a first digital-to-analog converter configured to generate the park voltage;
a second digital-to-analog converter configured to generate the data voltage; and
a selector configured to selectively output one of the park voltage and the data voltage.

5. The display device of claim 4, wherein the selector outputs the park voltage in response to a park voltage enable signal applied from the timing controller.

6. The display device of claim 4, wherein the first digital-to-analog converter comprises:
a resistor string circuit configured to divide a voltage into voltages having a plurality of levels based on a first reference voltage and a second reference voltage, and output the divided voltages; and
a controller configured to change a level of the park voltage based on the voltages output from the resistor string circuit and the park voltage control value, and output the level-changed park voltage.

7. The display device of claim 1, wherein the data driver comprises a plurality of data drivers,
wherein the plurality of data drivers generates the park voltage based on a park voltage reference voltage value output from a representative data driver.

8. The display device of claim 1, wherein one of the park voltage and the data voltage is output when the display panel operates in a variable refresh rate (VRR) driving mode.

9. The display device of claim 8, wherein the VRR driving mode includes:
a refresh frame for applying the data voltage through the data line connected to the subpixels of the display panel, and
an anode reset frame for applying the park voltage through the data line.

10. The display device of claim 9, wherein one of the subpixels comprises:
a driving transistor configured to supply a driving current to the light-emitting element, and
a transistor connected between the data line and the driving transistor.

11. The display device of claim 10, wherein the transistor is turned on in the refresh frame so that the data voltage is supplied to the driving transistor, and
wherein the transistor is turned off during a period in which the park voltage is provided to the data line in the anode reset frame.

12. A data driver comprising:
a first digital-to-analog converter configured to generate a park voltage and gamma reference voltages;
a second digital-to-analog converter configured to generate a data voltage based on the gamma reference voltages; and
a selector configured to selectively output one of the park voltage and the data voltage,
wherein the first digital-to-analog converter generates the park voltage based on an external park voltage control value.

13. The data driver of claim 12, wherein the selector outputs the park voltage in response to an external park voltage enable signal.

14. The data driver of claim 13, wherein the first digital-to-analog converter comprises:
a resistor string circuit configured to divide a voltage into voltages having a plurality of levels based on a first reference voltage and a second reference voltage, and output the divided voltages; and
a controller configured to change a level of the park voltage based on the voltages output from the resistor string circuit and the park voltage control value, and output the level-changed park voltage.

15. A display device comprising:
a display panel including subpixels, each of the subpixels having a light-emitting element; and
the data driver of claim 12 and configured to supply one of the park voltage or the data voltage to the subpixels through data lines.
